(19) United States
(12) Patent Application Publication
(10) Pub. No.: US 2019/0035546 A1
(43) Pub. Date: Jan. 31, 2019

(54) INTERNAL COMBUSTION ENGINE IGNITION DEVICE

(71) Applicant: Mitsubishi Electric Corporation, Tokyo (JP)

(72) Inventors: Shota YANAGI, Tokyo (JP); Takashi IDOGAWA, Tokyo (JP)

(73) Assignee: Mitsubishi Electric Corporation, Tokyo (JP)

(21) Appl. No.: 15/769,434

(22) PCT Filed: Apr. 12, 2016
(86) PCT No.: PCT/JP2016/061772

§ 371 Date: Apr. 19, 2018

(51) Int. Cl. H01F 38/12; F02P 3/02

(52) U.S. Cl. CPC H01F 38/12; H01F 2038/127; H01F 2038/122; F02P 3/02

(57) ABSTRACT

An internal combustion engine ignition device comprises: a center core; a primary coil wound on the outside of the center core; a secondary coil wound on the outside of the primary coil; a permanent magnet which abuts against one end of the center core and is magnetized in the inverse direction to the direction of a magnetic flux produced by the energization of the primary coil; a side core which is disposed on the outside of the secondary coil with one end abutted against the permanent magnet and the other end abutted against the center core, the side core cooperating with the permanent magnet to form a closed magnetic path; and a heat-resistant and elastic resin covering the side core with an opening at an outer peripheral side. Heat dissipation from the side core to a housing is improved without adversely affecting the dielectric strength voltage of the secondary coil.

### TECHNICAL FIELD

The present invention relates to an internal combustion engine ignition device that supplies a high voltage to the ignition plug of an internal combustion engine.

### BACKGROUND ART

Conventionally, an internal combustion engine ignition device includes a center core, a primary coil disposed on the outside of the center core so as to be wound around the center core, a secondary coil disposed so as to be wound around the center core on the outside of the primary coil, a magnet abutted against one end surface of the center core, the magnet being magnetized in the direction opposite to the direction of a magnetic flux produced by energization of the primary coil, a side core disposed on the outside of the primary coil and the secondary coil with one end abutted against the magnet and the other end abutted against the center core, the side core cooperating with the magnet to form a closed magnetic path, a case in which these members are housed, and an insulating resin with which the case is filled to fix these members. However, a crack may be generated in the insulating resin from the edge of the side core in this structure. If such a crack is generated, an electric field concentrates on the crack, the dielectric strength between the side core and the secondary coil is reduced, and the dielectric strength voltage is reduced.

As a measure against this, for example, PTL 1 proposes an internal combustion engine ignition coil in which the side core is covered with a flexible core cover. This can suppress the generation of a crack in the insulating resin and prevent the reduction in the dielectric strength voltage of the secondary coil.

### CITATION LIST

### Patent Literature

PTL 1: JP-A-2006-294914

### SUMMARY OF INVENTION

### Technical Problem

However, since the entire side core is covered with a flexible core cover in the conventional internal combustion engine ignition device in PTL 1, there is a problem in that the gap between the case and the side core becomes large, thereby causing the heat dissipation from the side core to be reduced and the outer dimensions of the device to be increased.

The invention addresses the problem described above with an object of providing an internal combustion engine ignition device that improves the heat dissipation from the side core without reducing the dielectric strength voltage of the secondary coil and has a small size.

### Solution to Problem

To solve the above problem, an internal combustion engine ignition device according to the invention includes a stick center core; a primary coil wound on an outside of the center core; a secondary coil wound around an outside of the primary coil; a permanent magnet abutted against one end surface of the center core, the permanent magnet being magnetized in a direction opposite to a direction of a magnetic flux produced by energization of the primary coil; a side core disposed on an outside of the secondary coil with one end abutted against the permanent magnet and the other end abutted against the center core, the side core cooperating with the permanent magnet to form a closed magnetic path; and a heat-resistant and elastic resin covering a surface of the side core, in which a part of the resin is opened, the part covering at least an outer peripheral side of the side core.

### Advantageous Effects of Invention

Since the internal combustion engine ignition device according to the invention is configured so that the part of the resin covering at least the outer peripheral side of the side core facing the housing is opened, it is possible to improve the heat dissipation from the side core to the housing without reducing the dielectric strength voltage of the secondary coil and reduce the device size.

### BRIEF DESCRIPTION OF DRAWINGS

FIG. 1 is a plan view illustrating a first aspect of an internal combustion engine ignition device according to embodiment 1.

FIG. 2 is a cross sectional view taken along line A-A in FIG. 1.

FIG. 3 is a cross sectional view illustrating the structure of a second aspect of the internal combustion engine ignition device according to embodiment 1.

FIG. 4 is a cross sectional view illustrating the structure of a third aspect of the internal combustion engine ignition device according to embodiment 1.

FIG. 5 is a plan view illustrating the structure of a first aspect of an internal combustion engine ignition device according to embodiment 2.

FIG. 6 is a cross sectional view taken along line B-B in FIG. 5.

FIG. 7 is a plan view illustrating the structure of a second aspect of the internal combustion engine ignition device according to embodiment 2.

FIG. 8 is a cross sectional view taken along line C-C in FIG. 7.

FIG. 9 is a plan view illustrating the structure of a first aspect of an internal combustion engine ignition device according to embodiment 3.

FIG. 10 is a cross sectional view taken along line D-D in FIG. 9.

FIG. 11 is a partial perspective view illustrating section E in FIG. 9.

FIG. 12 is a plan view illustrating the structure of a second aspect of the internal combustion engine ignition device according to embodiment 3.

FIG. 13 is a partial perspective view illustrating section F in FIG. 10.

FIG. 14 is a plan view illustrating the structure of a third aspect of the internal combustion engine ignition device according to embodiment 3.

FIG. 15 is a plan view illustrating the structure of a fourth aspect of the internal combustion engine ignition device according to embodiment 3.

FIG. 16 is a partial perspective view illustrating section G in FIG. 15.

### DESCRIPTION OF EMBODIMENTS

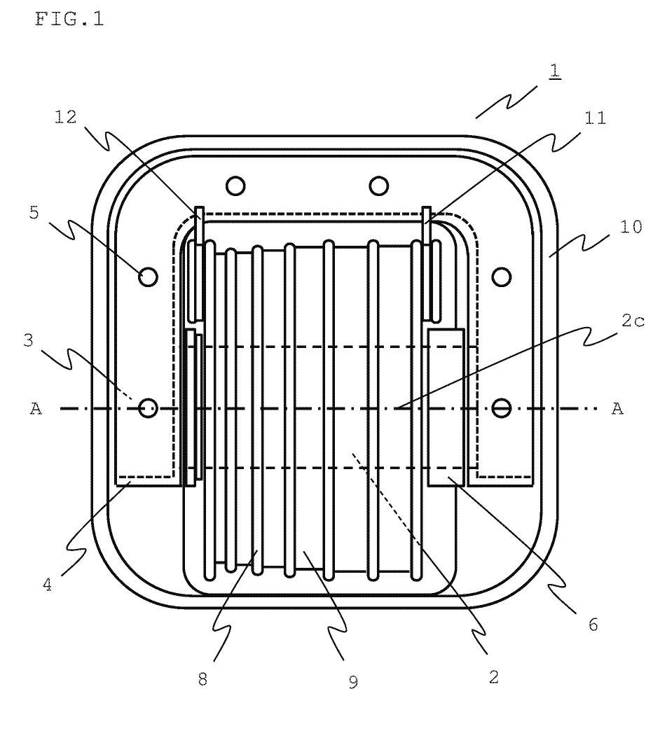

Details on internal combustion engine ignition devices according to embodiments of the invention will be described with reference to FIG. 1 to FIG. 16.

### Embodiment 1

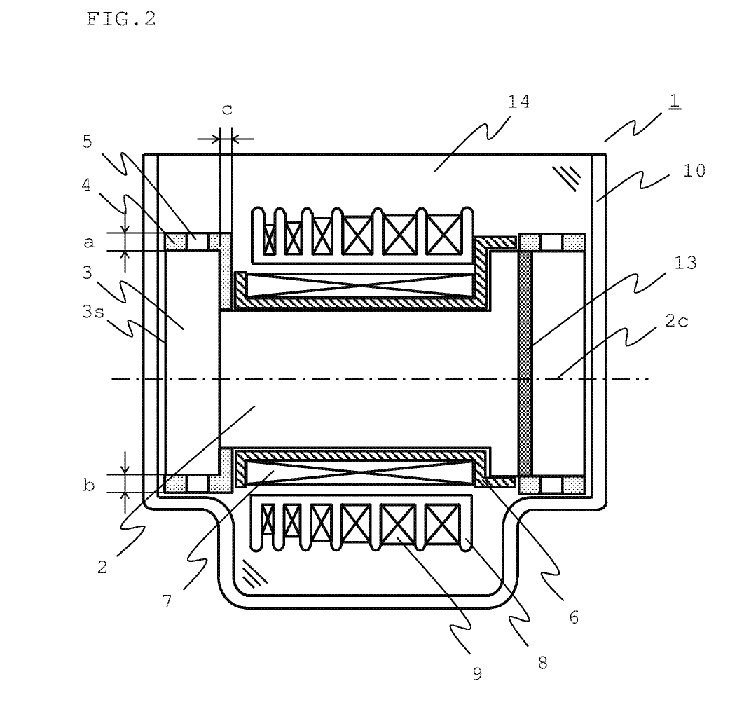

FIG. 1 is a plan view illustrating the first aspect of the internal combustion engine ignition device according to embodiment 1. FIG. 2 is a cross sectional view taken along line A-A in FIG. 1.

As illustrated in FIG. 1, an internal combustion engine ignition device 1 includes a stick center core 2, a primary coil 7 provided on the outside of the center core 2, the primary coil 7 being wound around a primary bobbin 6 with respect to a center axis 2c of the center core 2, a secondary coil 9 provided on the outside of the primary coil 7, the secondary coil 9 being wound around a secondary bobbin 8 in a divided manner with respect to the center axis 2c of the center core 2, a low voltage side terminal 11 and a high voltage side terminal 12 provided on the secondary coil 9, a permanent magnet 13 abutted against one end of the center core 2, the permanent magnet 13 being magnetized in the direction opposite to the direction of a magnetic flux produced by energization of the primary coil 7, a U-shaped side core 3 disposed on an outside of the primary coil 7 and the secondary coil 9 with one end abutted against the permanent magnet 13 and the other end abutted against the center core 2, the side core 3 cooperating with the permanent magnet 13 to form a closed magnetic path, a heat-resistant and elastic resin 4 covering the surface of the side core 3, housing 10 in which these members are housed, and an insulating resin 14 with which the housing 10 is filled. The resin 4 is provided with a through hole 5 and the part of the resin 4 covering an outer peripheral side 3s of the side core 3 is opened. During assembly, individual components are housed in the housing 10 and the through hole 5 of the resin 4 is filled with the insulating resin 14 to improve the contact with the resin 4.

In the internal combustion engine ignition device 1, the center core 2 is magnetically coupled to the side core 3, a closed magnetic path is formed via the permanent magnet 13 for promoting the formation of a magnetic field magnetized in the direction opposite to the direction of a magnetic flux produced by energization of the primary coil 7, and a high voltage induced in the secondary coil 9 is supplied to the ignition plug of the internal combustion engine by passing the primary current through the primary coil 7 or interrupting the primary current.

By opening the part of the resin 4 covering the outer peripheral side 3s of the side core 3, the gap between the side core 3 and the housing 10 can be reduced and the outer dimensions of the internal combustion engine ignition device 1 can be reduced. In addition, heat generated from the primary coil 7 and the secondary coil 9 can be radiated efficiently to the housing 10 by reducing the gap, and the thermal stress applied to the insulating resin 14 can be reduced and the occurrence of a crack in the insulating resin 14 can be suppressed by intervening the heat-resistant and elastic resin 4 between the side core 3 and the insulating resin 14. Since this can reduce the size of the internal combustion engine ignition device 1 without reducing the dielectric strength voltage of the secondary coil and improve the radiation efficiency, the reliability of the device can also be improved.

Preferably, the resin 4 is preferably heat-resistant elastomer resin such as silicone rubber. In addition, a hole used to fix the side core 3 when elastomer resin is molded onto the surface of the side core 3 may be used as the through hole 5 of the resin 4.

Since the outer peripheral side 3s of the side core 3 is not covered with the resin 4, by making the thicknesses a and b of the resin 4 on the upper and lower surfaces of the side core 3 larger than thickness c of the inner peripheral side of the side core 3 as illustrated in FIG. 2, it is possible to suppress the exfoliation of the resin 4 from the side core 3 due to thermal stress. In addition, since the outer peripheral side 3s of the side core 3 is not covered with the resin 4, the resin 4 does not make contact with the housing 10 during assembly and exfoliation of the resin 4 from the side core 3 can be prevented.

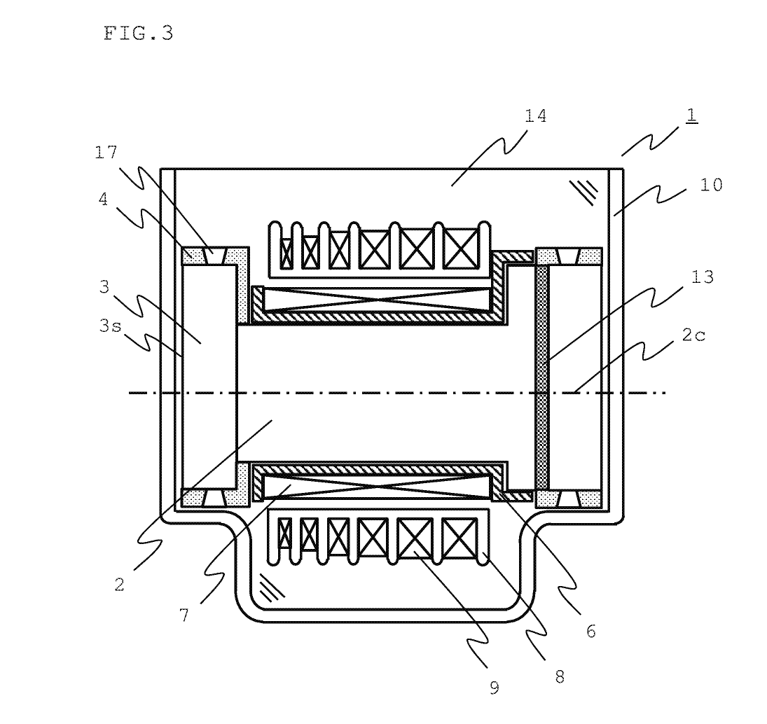

FIG. 3 illustrates the second aspect of the embodiment and the resin 4 is provided with a through hole 17, as the through hole, having an upper portion and a lower portion having a diameter smaller than the upper portion. In this aspect, this causes the insulating resin 14 to be sufficiently distributed uniformly within the through hole 17 when the through hole 17 is filled with the insulating resin 14, and improves the contact.

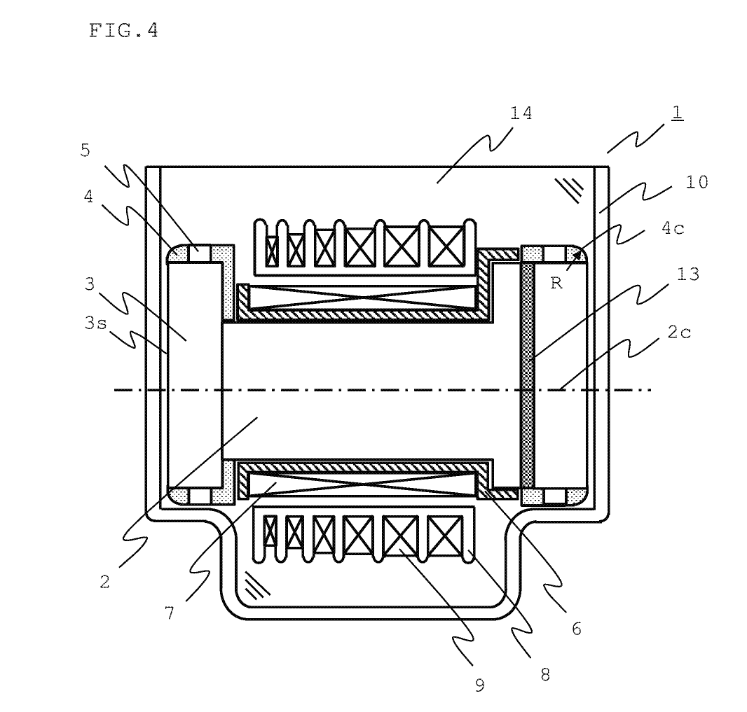

FIG. 4 illustrates the third aspect of the embodiment. An edge portion 4c of the resin 4 is provided with a curved surface having a curvature of R. This can suppress the exfoliation of the resin 4 from the side core 3 due to contact or the like when the side core 3 is inserted into the housing during assembly. In addition, since the curvature improves the contact between the resin 4 and the side core 3. The edge portion of the resin 4 may be tapered instead of providing the curved surface.

Although the side core 3 is U-shaped in the description of the above embodiment, the side core 3 may have another shape such as an O-shape.

As described above, in the internal combustion engine ignition device according to embodiment 1, the gap between the side core and the housing can be reduced by opening the outer peripheral side of the side core covered with the resin, the size of the internal combustion engine ignition device can be reduced without reducing the dielectric strength voltage of the secondary coil, heat generated from the primary coil and the secondary coil can be radiated efficiently to the housing by reducing the gap, and the thermal stress applied to the insulating resin can be reduce and the occurrence of a crack can be suppressed by intervening the heat-resistant and elastic resin.

### Embodiment 2

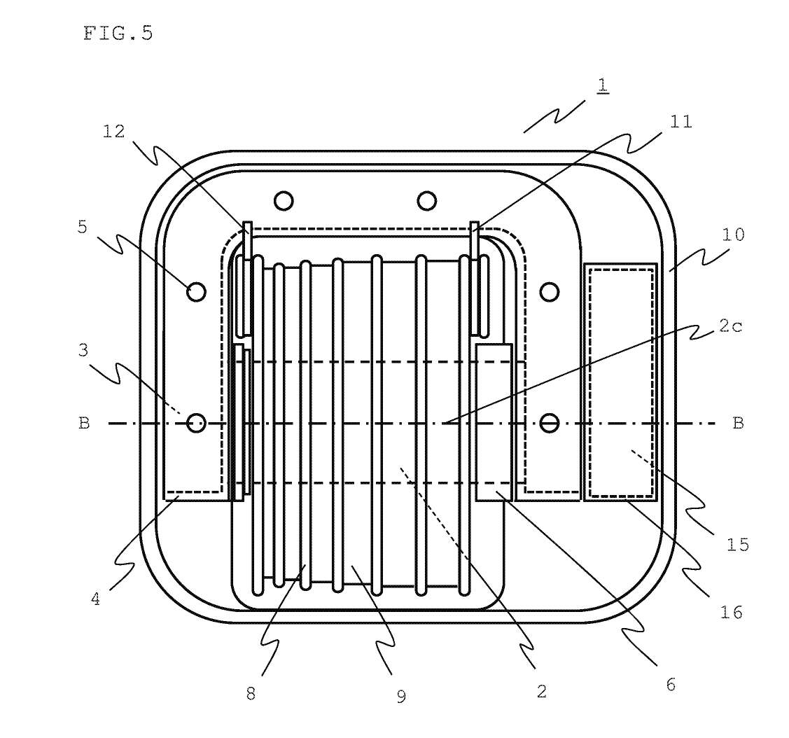

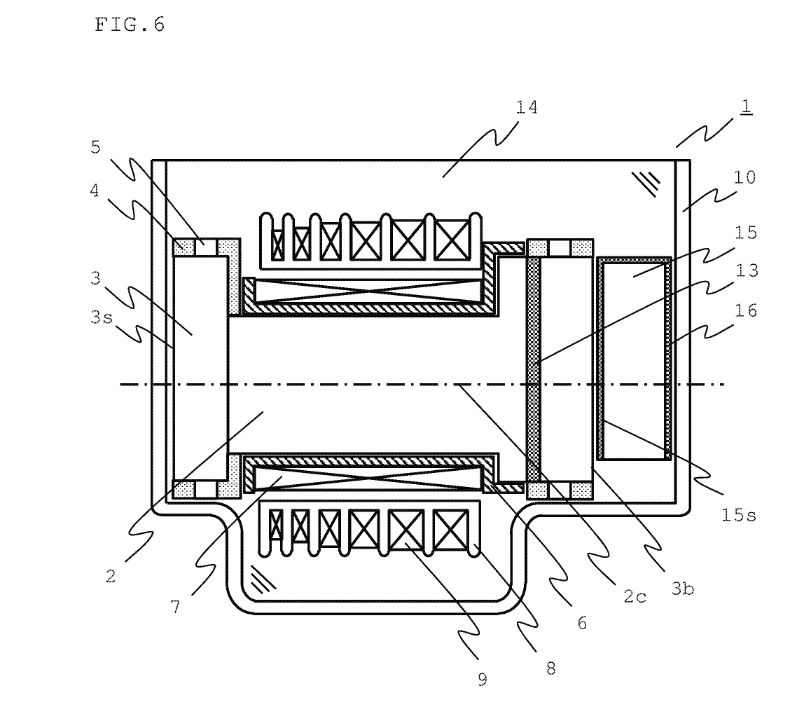

FIG. 5 is a plan view illustrating the structure of a first aspect of the internal combustion engine ignition device according to embodiment 2. FIG. 6 is a cross sectional view taken along line B-B in FIG. 5. The internal combustion engine ignition device according to embodiment 2 is the same as that according to embodiment 1 except that the internal combustion engine ignition device according to embodiment 2 includes a switching module 15 in the housing 10. Since the other structure and operation of the internal combustion engine ignition device according to embodiment 2 are the same as those of the internal combustion engine ignition device according to embodiment 1, descriptions are omitted.

As illustrated in FIG. 5 and FIG. 6, the switching module 15 that supplies, to the ignition plug of an internal combustion engine, a high voltage induced in the secondary coil 9 by passing a primary current through the primary coil 7 or interrupting the primary current is covered with an elastic body 16 and disposed so that a side 15s of the switching module 15 faces the outer peripheral side 3s of the side core 3. The elastic body 16 relieves thermal stress applied to switching module 15 from the primary coil 7 and the secondary coil 9. Since the switching module 15 is covered with the elastic body 16 here, the part of the resin 4 covering the outer peripheral side 3s of the side core 3 is unnecessary and the part is opened. The elastic body 16 may be made of rubber or the like that has elasticity.

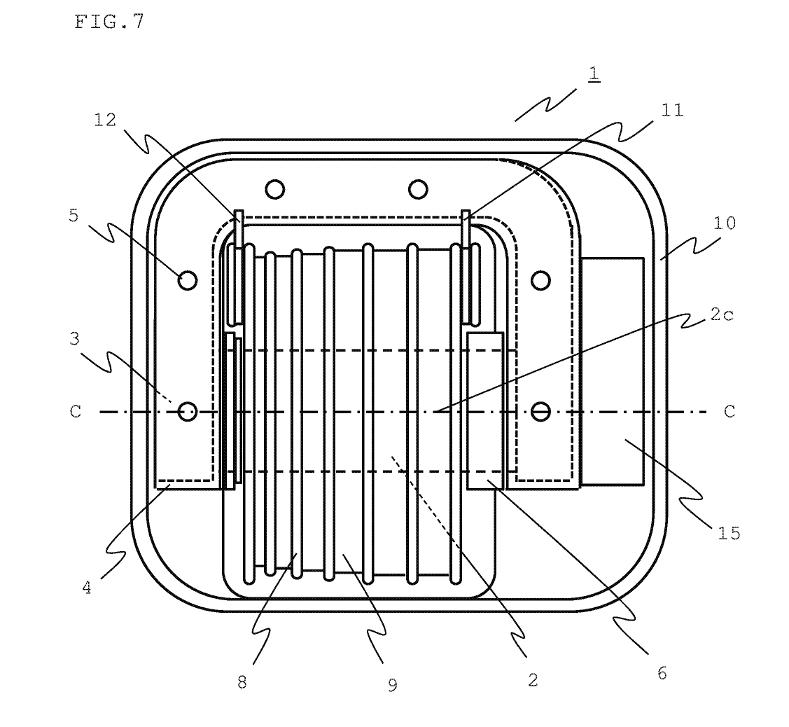

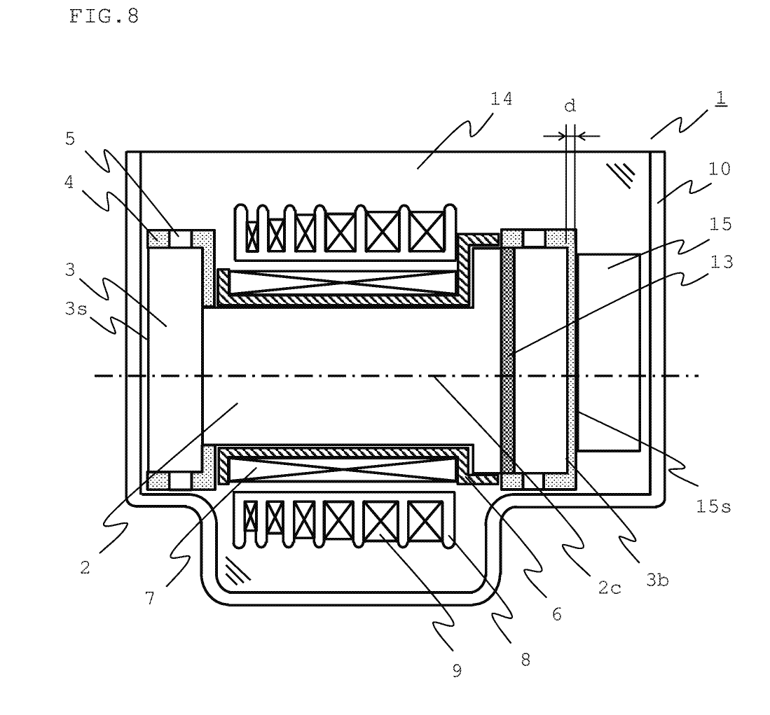

In addition, FIG. 7 is a plan view illustrating the structure of the second aspect of the internal combustion engine ignition device according to embodiment 2. FIG. 8 is a cross sectional view taken along line C-C in FIG. 7. Here, the outer peripheral side 3s of the side core 3 close to the side 15s of the switching module 15 is covered with the resin 4 having a thickness of d. Since the outer peripheral side 3s of the side core 3 close to the switching module 15 is provided with the resin 4, the elastic body 16 of the switching module 15 for measure against thermal stress becomes unnecessary and the outer dimensions of the internal combustion engine ignition device 1 can be reduced. In this aspect, the resin 4 covering the outer peripheral side 3s of the side core 3 can relieve thermal stress applied to the switching module 15. The thickness d of the resin 4 only needs to protect the switching module 15 from thermal stress applied by the primary coil 7 and the secondary coil 9.

Since this takes measures against thermal stress applied to the switching module 15 and eliminates the need for the elastic body 16, the number of components can also be reduced.

As described above, in the internal combustion engine ignition device according to embodiment 2, the same effects as in embodiment 1 can be obtained even when the switching module is built into the housing and thermal stress applied to the switching module can be relieved.

### Embodiment 3

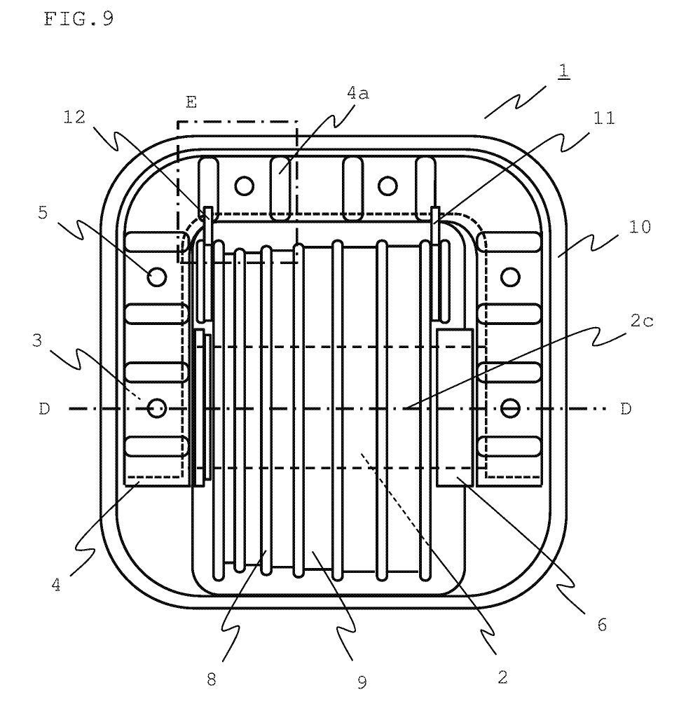

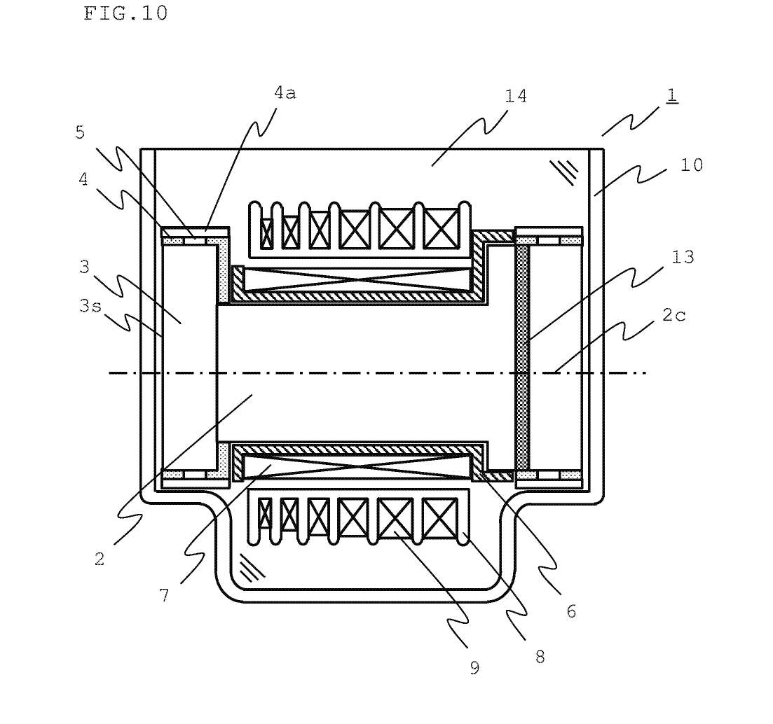

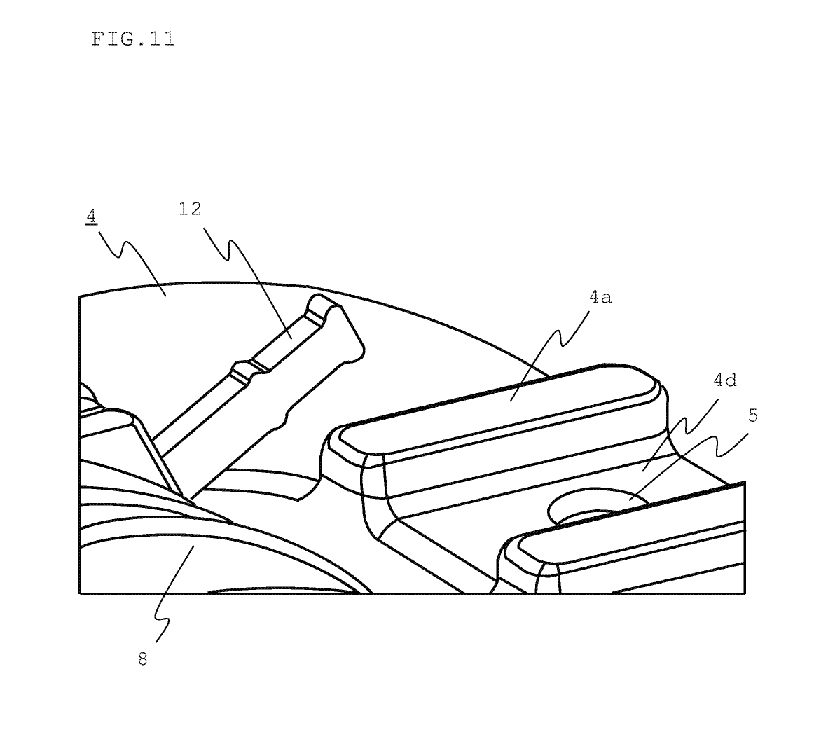

FIG. 9 is a plan view illustrating the structure of the first aspect of the internal combustion engine ignition device according to embodiment 3, FIG. 10 is a cross sectional view taken along line D-D in FIG. 9, and FIG. 11 is a partial perspective view illustrating section E in FIG. 9. This internal combustion engine ignition device is the same as the internal combustion engine ignition device according to embodiment 1 except that a ridge 4a is formed on the surface portion of the resin 4. Since the other structure and operation of the internal combustion engine ignition device according to embodiment 3 are the same as those of the internal combustion engine ignition device according to embodiment 1, descriptions are omitted.

As illustrated in FIG. 9 to FIG. 11, the ridge 4a only needs to be provided in a position other than the position of the through hole 5 provided in the resin 4 and the number of the ridges 4a and the position of the ridge 4a are not particularly limited. The presence of the ridge 4a on the resin 4 increases the strength, can relieve the stress applied when the resin 4 is molded to the side core 3, and can suppress the exfoliation of the resin 4 from the side core 3. In addition, the ridge 4a can relieve the thermal stress from the primary coil 7 and the secondary coil 9 and suppress exfoliation. This can suppress the thickness of a flat portion 4d of the resin 4 and reduce the amount of resin used, as compared with the case in which the resin 4 is configured to have a uniform thickness. It should be noted that as is clear from the partial perspective view illustrating section E in FIG. 11, a sufficient gap is taken between the high voltage side terminal 12 of the secondary coil 9 and the ridge 4a.

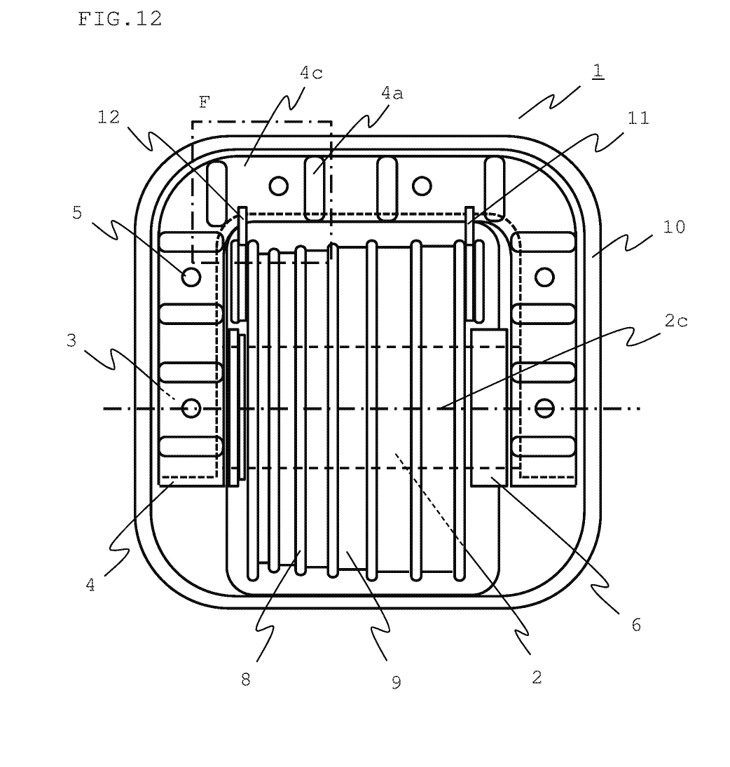

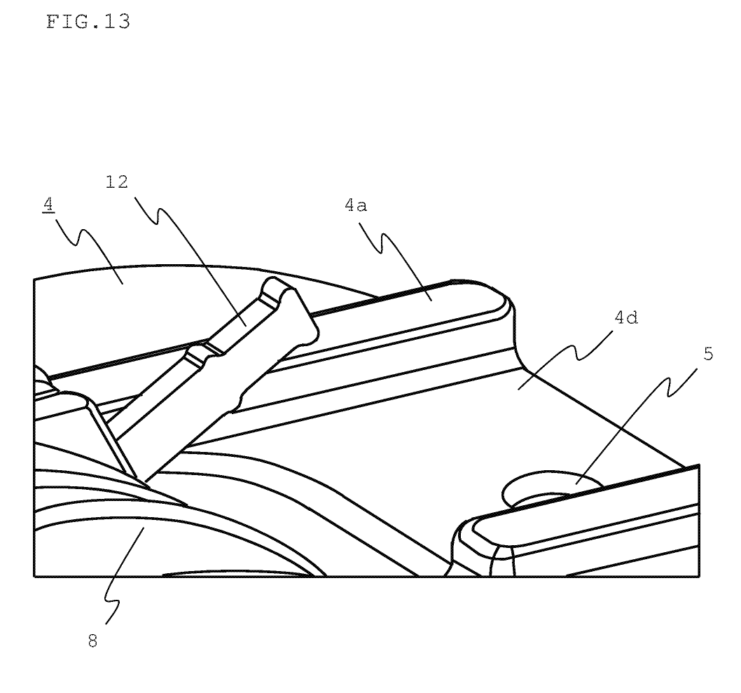

In addition, FIG. 12 is a plan view illustrating the structure of the second aspect of the internal combustion engine ignition device according to embodiment 3. FIG. 13 is a partial perspective view illustrating section F in FIG. 12. Here, the ridge 4a is provided in a position away from the high voltage side terminal 12 so that the high voltage side terminal 12 of the secondary coil 9 faces the flat portion 4d of the resin 4. Since the withstand voltage of the insulating resin 14 is higher than that of the resin 4, the amount of the insulating resin 14 around the high voltage side terminal 12 increases by keeping the flat portion 4d of the resin 4 away from the high voltage side terminal 12, the withstand voltage of the secondary coil 9 can be improved, and the internal combustion engine ignition device can have a small size and a high withstand voltage.

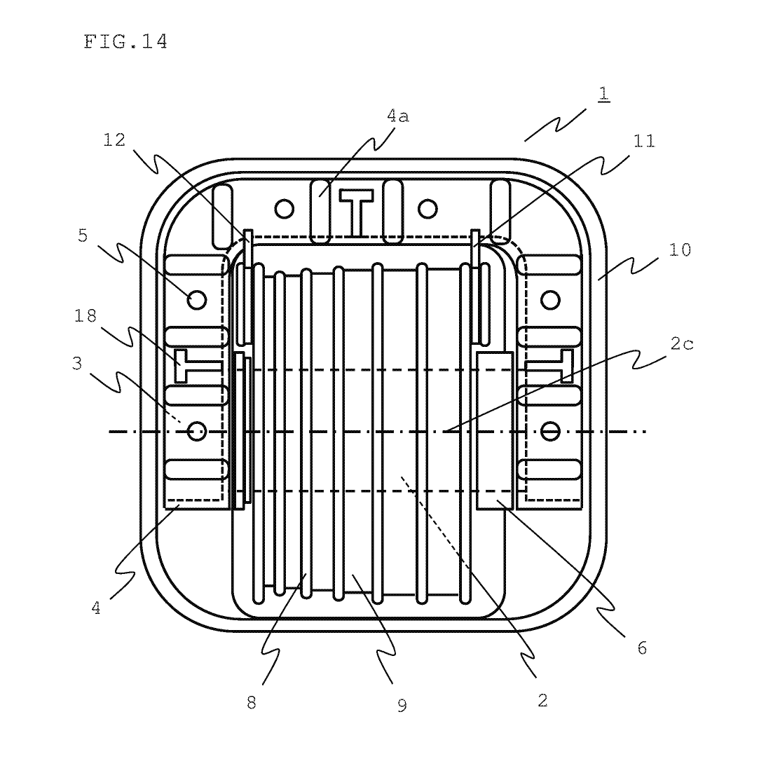

In addition, FIG. 14 is a plan view illustrating the structure of the third aspect of the internal combustion engine ignition device according to embodiment 3. Here, a T-shaped through hole 18 is provided in the resin 4 in addition to the through hole 5. The tensile stress applied in the radial direction and the longitudinal direction of the resin 4 can be relieved by providing an opening. The through hole 5 may be T-shaped. Of course, it will be appreciated that the resin in embodiment 1 that has no ridge is also applicable.

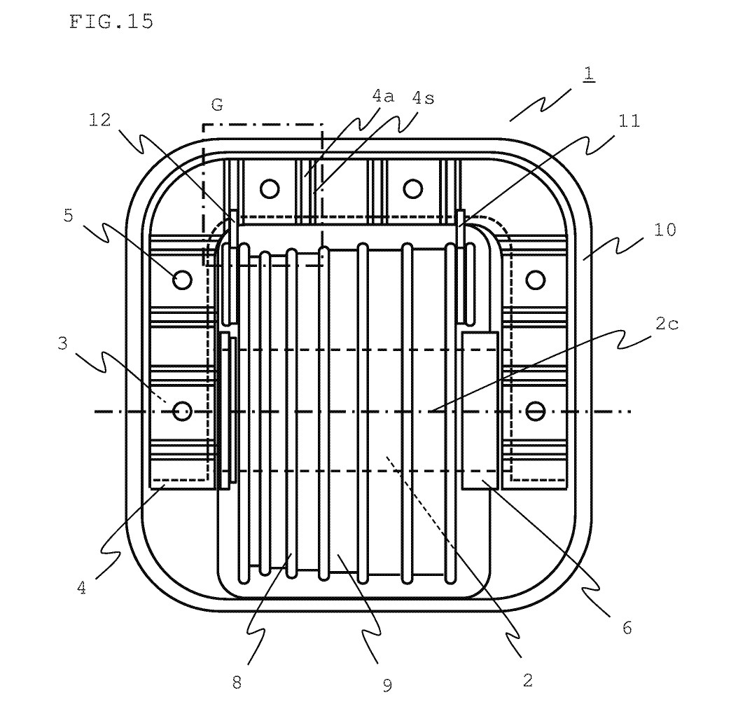

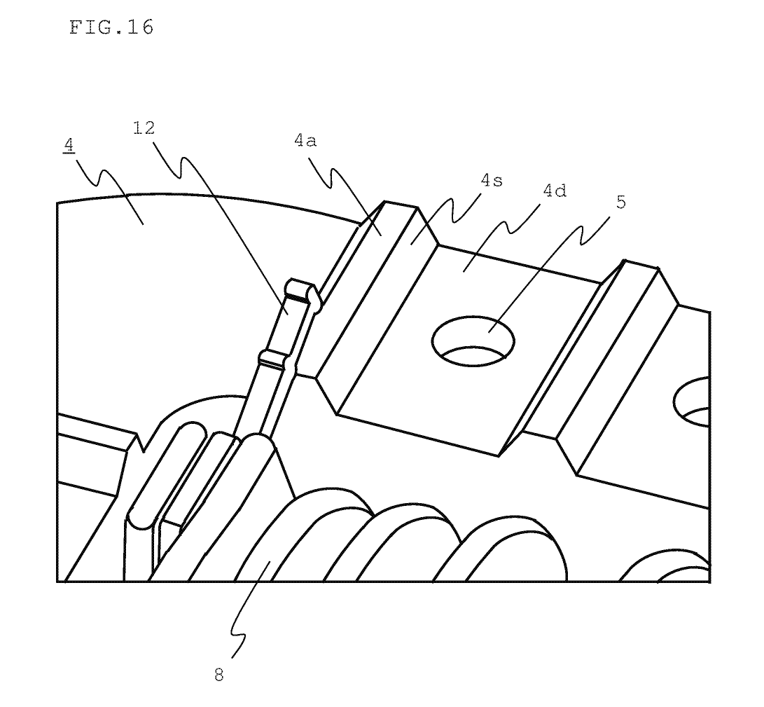

In addition, FIG. 15 is a plan view illustrating the structure of the fourth aspect of the internal combustion engine ignition device according to embodiment 3. FIG. 16 is a partial perspective view illustrating section G in FIG. 15. Here, a side 4s of the ridge 4a provided on the resin 4 has an inclined surface formed between an end portion and a bottom portion larger than the end portion. Accordingly, the insulating resin 14 is sufficiently distributed onto the surface portion of the resin 4 when the through hole is filled with the insulating resin 14 and the contact is improved in this aspect.

As described above, in the internal combustion engine ignition device according to embodiment 3, the same effects as in embodiment 1 can be obtained and the exfoliation of the resin can be suppressed by providing a ridge on the resin covering the side core.

In addition, individual embodiments may be combined freely or individual embodiments may be modified or omitted as appropriate within the scope of the invention.

In addition, the same reference numeral represents the same component or an equivalent component in the drawings.

### REFERENCE SIGNS LIST

1: internal combustion engine ignition device

2: center core

3: side core

3s: outer peripheral side

4: resin

4a: ridge

4s: side

4c: edge portion

4d: flat portion

5, 17, 18: through hole

6: primary bobbin

7: primary coil

8: secondary bobbin

9: secondary coil

10: housing

11: low voltage side terminal

12: high voltage side terminal

13: permanent magnet

14: insulating resin

15: switching module

16: elastic body

1. An internal combustion engine ignition device comprising:
a stick center core;
a primary coil wound on an outside of the center core;
a secondary coil wound around an outside of the primary coil;
a permanent magnet abutted against one end surface of the center core, the permanent magnet being magnetized in a direction opposite to a direction of a magnetic flux produced by energization of the primary coil;
a side core disposed on an outside of the secondary coil with the one end abutted against the permanent magnet and the other end abutted against the center core, the side core cooperating with the permanent magnet to form a closed magnetic path; and
a heat-resistant and elastic resin covering a surface of the side core,
wherein a part of the resin is opened, the part covering at least an outer peripheral side of the side core.

2. The internal combustion engine ignition device according to claim 1,
wherein a through hole is provided in the resin.

3. The internal combustion engine ignition device according to claim 2,
wherein the diameter of the through hole close to the surface is larger than the diameter of the through hole close to the side core.

4. The internal combustion engine ignition device according to claim 1,
wherein an edge portion of the resin has a curved surface.

5. The internal combustion engine ignition device according to claim 1,
wherein the thickness of a part of the resin having a side on the outer peripheral side of the side core is larger than the thickness of the other part of the resin.

6. The internal combustion engine ignition device according to claim 1,
wherein a ridge is provided on a surface of the resin.

7. The internal combustion engine ignition device according to claim 6,
wherein a side of the ridge is an inclined surface formed between an end side and a bottom side larger than the end side.

8. The internal combustion engine ignition device according to claim 6,
wherein the secondary coil is provided with a high voltage side terminal and a flat portion of the resin is provided in a position facing the high voltage side terminal.

9. The internal combustion engine ignition device according to claim 1, further comprising:
a switching module that supplies, to an ignition plug of an internal combustion engine, a high voltage induced in the secondary coil by passing a primary current through the primary coil or interrupting the primary current.
